(19) United States
(12) Patent Application Publication
(10) Pub. No.: US 2006/0259208 A1
(43) Pub. Date: Nov. 16, 2006

(54) Vehicle control system

(75) Inventor: Atsushi Ota, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/415,313

(22) Filed: May 2, 2006

(30) Foreign Application Priority Data
May 6, 2005 (JP) 2005-135327

(51) Int. Cl. G06F 17/00

(52) U.S. Cl. 701/1

(57) ABSTRACT

A vehicle control system for a vehicle is disclosed. The vehicle control system includes a communication network and a plurality of control units in communication with each other via the communication network. At least one of the control units includes a nonvolatile memory device with a write environment determination program written thereon. This control unit receives vehicle data from at least one other control unit. The write environment determination program is run to determine whether a writing environment is appropriate based on the vehicle data, and a writing process of the control program commences when it is determined that the writing environment is appropriate.

### CROSS REFERENCE TO RELATED APPLICATION

This application is based upon and claims the benefit of priority of Japanese Patent Application No. 2005-135327 filed on May 6, 2005, the content of which is incorporated herein by reference.

### FIELD OF THE INVENTION

The present invention relates to a vehicle control system and, more particularly, relates to a vehicle control system with a plurality of control units, which operate according to a control program.

### BACKGROUND OF THE INVENTION

It is known to provide a memory system to which a control program can be written or rewritten thereon. For instance, Japanese Patent Publication Number 09-139094 discloses an control unit in which a flash ROM memory device is provided as a storage medium to store a control program of a vehicle. Also, the flash ROM memory device is constructed to enable rewriting of the control program after being mounted to the vehicle. Thus, the control program can be written to the flash ROM memory at a convenient time during vehicle manufacture. Also, the control program can be rewritten on the flash ROM memory device (e.g., to update the control program) while being mounted to the vehicle.

Specifically, the system disclosed in Japanese Patent Publication Number 09-139094 includes an ECU provided with a flash ROM and a memory rewriting device that is in communication with the ECU. In order to write to or rewrite the flash ROM, the memory rewriting device outputs a voltage, and the voltage is detected by an A/D converter to detect whether the voltage is within a predetermined range suitable for writing to the flash ROM. If the voltage is outside the predetermined range, an adjustment signal is outputted to the memory rewriting device. The memory rewriting device then adjusts the voltage to the predetermined range according to the adjustment signal such that the voltage is appropriate for writing to the flash ROM. Then, the memory rewriting device begins transmitting the control program at the appropriate voltage, and the ECU sequentially writes the control program on the flash ROM.

Accordingly, the control units perform an A/D conversion for the purpose of detecting whether the rewrite voltage is within the predetermined range. Such processing is performed by a boot program stored in memory, for instance, in the flash ROM. The boot program may take up significant memory, especially where various rewrite processes are to be performed.

Furthermore, a determination processing program for detecting whether the rewrite voltage is within the predetermined range can be included on the flash ROM. However, if the determination processing program includes various functions, it may take a significant amount of time to write the program.

### SUMMARY OF THE INVENTION

A vehicle control system for a vehicle is disclosed. The vehicle control system includes a communication network and a plurality of control units in communication with each other via the communication network. At least one of the control units includes a nonvolatile memory device with a write environment determination program written thereon. This control unit receives vehicle data from at least one other control unit. The write environment determination program is run to determine whether a writing environment is appropriate based on the vehicle data, and a writing process of the control program commences when it is determined that the writing environment is appropriate.

A vehicle control system is also disclosed that includes a communication network and a plurality of control units in communication with each other via the communication network. A first control unit includes a nonvolatile memory device with a control program written thereon and a write program written thereon. The write program is used for a writing process of the control program. A second control unit includes a write determination program written thereon, and the write determination program is run to determine whether a writing environment is appropriate. The first control unit commences the writing process of the control program when the second control unit determines that the writing environment is appropriate.

Furthermore, a method for writing a control program of a vehicle control system is disclosed. The vehicle control system includes a plurality of control units. The method involves acquiring vehicle data by a control unit, transmitting the vehicle data to another control unit, and determining whether a write environment is appropriate based on the vehicle data. The method also involves commencing a writing process of the control program when it is determined that the write environment is appropriate.

### BRIEF DESCRIPTION OF THE DRAWINGS

FIG. 1 is a schematic illustration of one embodiment of a vehicle control system;

FIG. 2 is a schematic illustration of a flash ROM of an engine control unit for the vehicle control system of FIG. 1;

FIG. 3 is a flowchart illustrating a method of operating the engine control unit of FIG. 1 when a control program is written;

FIG. 4 is a flowchart illustrating a second embodiment of determining whether the write environment is appropriate; and

FIG. 5 is a flowchart illustrating a writing process carried out by the engine control unit in the second embodiment.

### DETAILED DESCRIPTION OF THE INVENTION

A vehicle control system according to embodiments of the invention will be described with reference to drawings.

### First Embodiment

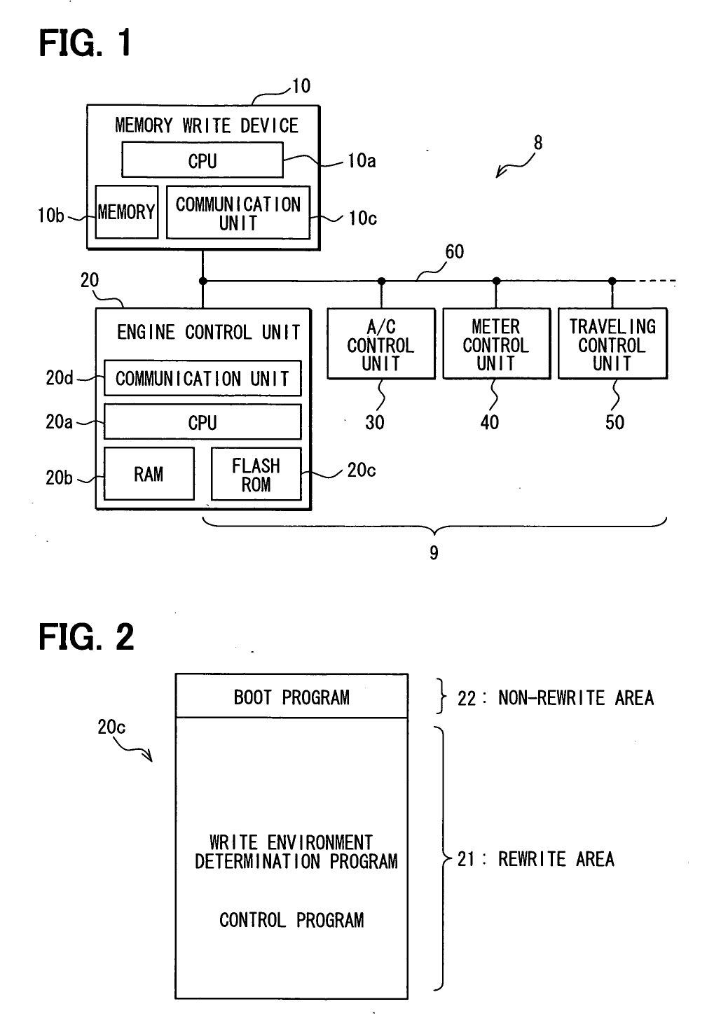

FIG. 1 is a block diagram schematically illustrating one embodiment of a vehicle control system 8. The vehicle control system 8 is mounted to a vehicle (not shown). The vehicle control system 8 includes a plurality of control units 9. The control units 9 each control a separate device of the vehicle. In the embodiment shown, the control units 9 include an engine control unit (ECU) 20, an air-conditioner control unit 30, a meter control unit 40, and a traveling control unit 50, each of which will be described in greater detail below. It will be appreciated that the vehicle control system 8 could include any number of control units 9 of any suitable type without departing from the scope of the present disclosure.

The vehicle control system 8 also includes a communication network 60 that establishes electrical communication between each of the control units 9. In one embodiment, the communication network 60 is a local area network (i.e., an in-vehicle LAN), which uses CAN protocol as the communication protocol. The communication network 60 enables the control units 9 to share data about the vehicle as will be described.

The engine control unit 20 includes a CPU 20a that performs various arithmetic processes according to a control program and a RAM unit 20b that temporarily preserves results of the arithmetic processes of the CPU 20a. The CPU 20a also includes a flash ROM 20c on which the control program is written and which stores a write control program as will be discussed. The CPU 20a further includes a communication unit 20d that performs mutual communication with the other control units 9 of the vehicle.

Further, the engine control unit 20 includes an input circuit, into which information detected by various sensors (not shown) is input. The sensors detect an operating state of the engine, and the information detected by the sensors is input to the input circuit of the engine control unit 20. The engine control unit 20 also includes an output circuit that outputs a drive signal to an actuator, such as an injector, an igniter, or the like, in the engine. Thus, the engine control unit 20 can generate a drive signal on the basis of the information detected by the sensors according to the control program stored in the flash ROM 20c. The drive signal can be outputted to the actuator (e.g., the injector, igniter, etc.). As a result, the engine control unit 20 can appropriately control the operating state of the engine.

Furthermore, the air-conditioner control unit 30, the meter control unit 40, and the traveling control unit 50 each include a CPU, RAM, ROM, a communication unit, etc. similar to those of the engine control unit 20. In addition, the air-conditioner control unit 30, the meter control unit 40, and the traveling control unit 50 each include a detector of battery voltage (e.g., an A/D conversion circuit, etc.) for confirming whether a necessary operating voltage is supplied from a battery of a vehicle.

For example, the air-conditioner control unit 30 includes a plurality of sensors (not shown) that individually detect passenger compartment temperature, the outside air temperature, the amount of solar radiation, the engine water temperature, or other similar temperature data. The air-conditioner control unit 30 outputs detected temperature data and battery voltage information to other control units 9 units via the communication network 60. The temperature data is also used to maintain the passenger compartment at a desired temperature. More specifically, when the air-conditioner control unit 30 is set to a desired temperature, the air-conditioner control unit 30 detects the passenger compartment temperature, the outside air temperature, the amount of solar radiation, the engine water temperature, and the like with the respective sensors, and the air-conditioner control unit 30 controls an air outlet, the blowoff air volume, the blowoff air temperature, and the like according to the data detected by the sensors so as to maintain the passenger compartment at the desired temperature.

The meter control unit 40 includes a speedometer, a tachometer, a fuel level gauge and other like components. In one embodiment, the meter control unit 40 includes an analog-type speedometer and a speed sensor mounted to a transaxle to indicate vehicle speed to the driver. Also, the ignition signal from an igniter is detected and the signal is communicated to the tachometer to display the engine speed to the driver. Thus, the meter control unit 40 comprises a vehicle speed sensor and outputs speed information detected by the vehicle speed sensor. The meter control unit 40 outputs the speed information and also battery voltage information to other control units 9 via the communication network 60.

The traveling control unit 50 includes at least one subsystem for controlling the driving performance of the vehicle. For instance, in one embodiment, the traveling control unit 50 includes a wheel antilock subsystem that reduces lock of one or more vehicle wheels and a traction control subsystem that improves the traction of the vehicle wheels in a variety of driving conditions. These subsystems detect the wheel speed and the vehicle speed. The traveling control unit 50 outputs the detected wheel speed and the vehicle speed via the communication network 60, and the battery voltage is also output via the communication network 60.

Referring now to FIG. 2, the flash ROM 20c of the engine control unit 20 is illustrated in detail. The flash ROM comprises a rewrite area 21, in which data can be electrically rewritten. More specifically, old data is erased, and new data is written in the rewrite area 21. The flash ROM also includes a non-rewrite area 22, in which rewriting of data is inhibited. The control program described above is written on the rewrite area 21 of the flash ROM 20c to be stored. Also, a boot program is stored in the non-rewrite area 22 of the flash ROM 20c. The boot program is executed at the time of writing of the control program and performs a process such as downloading a rewrite control program to the RAM 20b, etc.

Further, a “write environment determination program” is included on the flash ROM 20c as shown in FIG. 2. The write environment determination program is used for determining whether the state of the vehicle is suitable (i.e., appropriate) for rewriting the control program as will be discussed in greater detail below. In the embodiment shown, the write environment determination program is included in the rewrite area 21 of the flash ROM 20c; however, it will be appreciated that the write environment determination program may be included in the non-rewrite area 22 of the flash ROM without departing from the scope of the present disclosure. For instance, in cases in which it suffices to write a control program once on the flash ROM 20c for engine control (e.g., at the time of manufacture of a vehicle), the write environment determination program may be stored in the rewrite area 21 and erased at the time of writing of the control program. On the other hand, in cases in which it is necessary to enable writing of the control program a plurality of times, the write environment determination program may be stored in the non-rewrite area 22.

A memory write device 10 is also illustrated in FIG. 1. The memory write device 10 includes a CPU 10a, a memory component 10b, and a communication unit 10c. In one embodiment, the memory write device 10 is removably attached to the communication network 60. At a desired time, the memory write device 10 outputs a control program writing request, and the CPU 20a of the engine control unit 20 subsequently writes the control program to the flash ROM 20c.

More specifically, the CPU 10a of the memory write device 10 outputs, via the communication unit 10c, a request for writing to the engine control unit 20 being an control unit on which writing is made. Upon receiving the writing request, the engine control unit 20 executes the “write environment determination program” to determine if the state of the vehicle is suitable for writing. If it is determined that the environment is appropriate for writing, the boot program is executed, and the rewrite control program is downloaded from the memory 10b of the memory write device 10 to the RAM 20b of the engine control unit 20. Thereafter, a process of writing write data (i.e., the control program) transmitted from a memory rewrite device on the write area of the flash ROM 20c is performed by calling the rewrite control program to execute the same on the RAM 20b.

Furthermore, in the case where the control program has already been stored in the flash ROM 20c, the control program is merely rewritten into a new control program and is executed in the same manner as the writing process at the time of vehicle manufacture.

As will be discussed, a basis for determining whether a “write environment” is appropriate is provided in order to simplify the write environment determination program. The suitability of the “write environment” depends on one or more pieces of vehicle data (e.g., the environmental temperature to which the flash ROM 20c is exposed, the battery voltage, the speed of the vehicle, etc.). For instance, in one embodiment, the write environment is appropriate (i.e., the write data can be written) when the temperature to which the flash ROM 20c is exposed is within a predetermined range, the battery voltage is above a predetermined voltage, and the vehicle is stopped.

Instead of independently collecting the vehicle data, the engine control unit 20 acquires the vehicle data from the air-conditioner control unit 30, the meter control unit 40, and/or the traveling control unit 50. In other words, it is unnecessary for the engine control unit 20 to independently collect information by means of an A/D conversion processing or the like, and it is thereby possible to simplify the write environment determination program. Accordingly, the memory capacity necessary for storage of the program can be reduced and the time necessary for fabricating the program can be reduced as well.

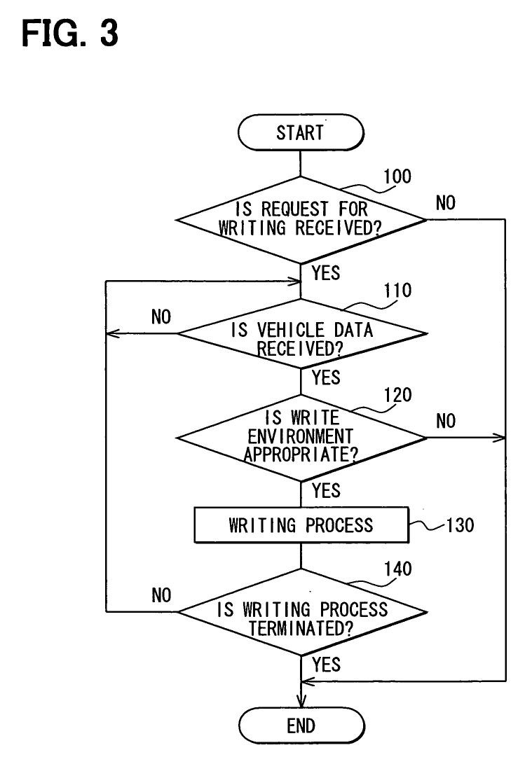

One embodiment of a method of writing the control program for the engine control unit 20 is described in detail with reference to FIG. 3. In one embodiment, the method can begin after the vehicle ignition switch is turned to an ON position.

In decision block 100, it is determined whether a request for writing has been received from the memory write device 10. In other words, when the memory write device 10 is connected to the communication network 60 and the operator sends a request signal for writing output from the memory write device 10, the engine control unit 20 receives the request for writing, and “YES” is determined in decision block 100. If, on the other hand, the memory write device 10 is disconnected from the communication network 60 or the like, “NO” is determined in decision block 100, and the engine control unit 20 operates according to the control program already written thereon.

Then, in decision block 110, it is determined whether the communication unit 20d has received vehicle data (e.g., environmental temperature, battery voltage, vehicle speed information, and/or other data detected by the control units 9) from another control unit 9. If the communication unit 20d has received vehicle data from another control unit 9, the engine control unit 20 preserves such received information in the RAM 20b. In other words, since it suffices in decision block 110 to determine whether vehicle data has been received, including data already preserved in the RAM 20b, it is possible to perform the determination processing (described later) immediately. Therefore, as described later, the determination processing can be performed also during the write processing of the control program.

If all of the vehicle data has not been received, “NO” is determined in decision block 110. A determination of “NO” causes the procedure to stand by until all of the necessary vehicle data has been received. When all of the vehicle data has been received, “YES” is determined in decision block 110, and the procedure proceeds to decision block 120.

Some of the data detected by the control units 9 and received by the engine control unit 20 may be redundant. For instance, several of the control units 9 detect battery voltage and/or vehicle speed. Thus, in one embodiment, “YES” is determined in decision block 110 (i.e., all necessary vehicle data has been received) even when communication is not made with each control units 9. As a result, the write environment determination can be completed without collecting redundant vehicle data. In another embodiment, “YES” is determined in decision block 110 once redundant vehicle data has been received from the plurality of control units 9. As such, the redundant information can provide more accurate assessment of whether the write environment is suitable.

In decision block 120, it is determined whether the write environment is appropriate. More specifically, it is determined in decision block 120 whether the state of the vehicle is one that is suitable for writing the control program based on the vehicle data received from the control units 9.

In one embodiment, “YES” is detected in decision block 120 when the engine speed is zero. Thus, the engine speed sensor is used to calculate an engine speed, and if the engine speed is zero, then “YES” will be detected in decision block 120. It may be desirable to write the control program when the engine speed is zero because it may be necessary to calculate an engine speed in the engine control unit 20. Also, since determination information other than an engine speed is acquired from other control units 9, it is possible to simplify the write environment determination program as compared with the related art.

If the writing environment is inappropriate (i.e., “NO” is determined in decision block 120), then the process is terminated without carrying out the write processing. However, if the writing environment is appropriate (i.e., “YES” is determined in decision block 120), the procedure proceeds to step 130, and the writing process occurs.

During step 130, a write control program is downloaded from the memory write device 10, and control programs discretely transmitted from the memory write device 10 are written in order on a rewrite area of the flash ROM 20c by the write control program.

Next in decision block 140, it is determined whether all control programs that are intended to be written have been written on the flash ROM 20c. Specifically, whether the writing process is terminated or not can be determined on the basis of, for example, whether transmission of write data (i.e., the control program) from the memory write device 10 continues.

If all of the control programs have been written, then “YES” is determined in decision block 140, and the process terminates. However, if other control programs are to be written, then “NO” is determined in decision block 140, and the process returns to decision block 110.

It is possible to detect a change in write environment while the control programs are written. Thus, if the writing environment becomes unsuitable for writing while the control programs are written, the writing process is suspended or stopped. Then, once the environment again becomes suitable for writing, writing is resumed. In one embodiment, writing returns to the same point at which writing was suspended. In another embodiment, writing is performed from the beginning.

Also, in one embodiment, the engine control unit 20 transmits a signal to the meter control unit 40 indicative of the progress of the writing process. The meter control unit 40 can thus indicate and/or display whether all of the determination information has been received, whether the write environment is appropriate, whether the write processing is completed, and/or any other suitable message.

### Second Embodiment

In a second embodiment, the write environment determination program is included with a control unit 9 other than the engine control unit 20. If that control unit 9 (i.e., other than the engine control unit 20) determines that the write environment is suitable for writing, then that control unit 9 transmits a writing instruction signal to the engine control unit 20, and the writing process then occurs. Accordingly, the program for the writing process of the engine control unit 20 can be further simplified because the write environment determination program is not included with the engine control unit 20.

In this embodiment, the control unit 9 that includes the write environment determination program may use a sensor or the like to acquire vehicle data used for determining whether the write environment is suitable. Alternatively, the control unit 9 that includes the write environment determination program may simply receive the information from other control units 9 instead of independently acquiring the vehicle data.

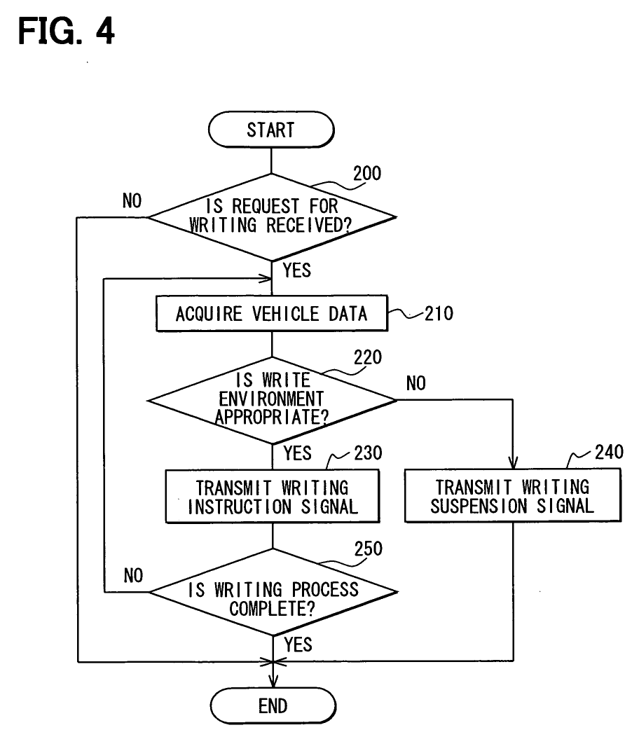

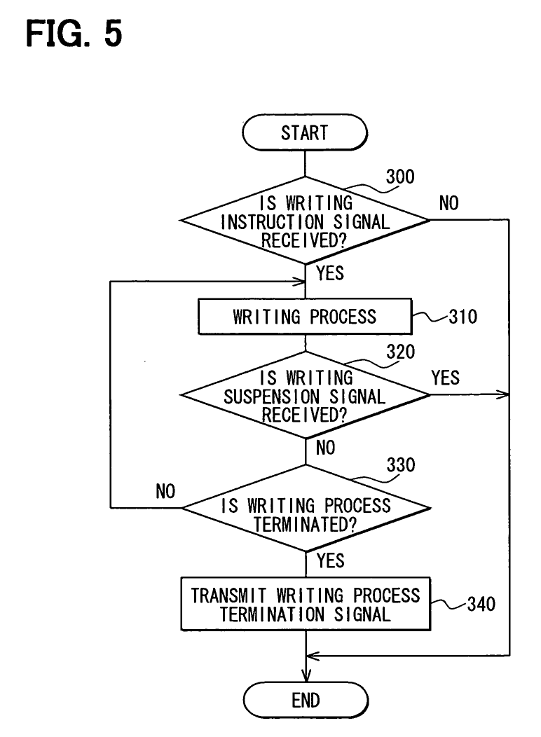

FIG. 4 is a flowchart illustrating the method of determining whether the write environment is appropriate in the second embodiment, and FIG. 5 is a flowchart illustrating a method of writing to the engine control unit 20 in the second embodiment.

As shown in FIG. 4, the control unit 9 with the write environment determination program (i.e., other than the engine control unit 20) first determines in decision block 200 whether a request for writing is received from the memory write device 10. If decision block 200 is answered negatively, the write environment determination program is terminated. However, if decision block 200 is answered affirmatively, step 210 follows.

In step 210, the control unit 9 with the write environment determination program acquires vehicle data from associated sensors and/or from the other control units 9. Then, in decision block 220, it is determined whether the write environment is appropriate based on the acquired vehicle data. If decision block 220 is answered negatively, step 240 follows and a writing suspension signal is transmitted to the engine control unit 20. However, if decision block 220 is answered affirmatively, the procedure proceeds to step 230, and a writing instruction signal is transmitted to the engine control unit 20.

Once the writing instruction signal is transmitted in step 230, it is determined in decision block 250 whether the writing process has been completed in the engine control unit 20. The determination in decision block 250 is based on whether a write processing termination signal transmitted from the engine control unit 20 is received.

If decision block 250 is answered affirmatively, the process is completed. However, if decision block 250 is answered negatively, the procedure returns to step 210, and vehicle data is acquired again in step 210. Then, it is determined again whether the write environment is appropriate in decision block 220 as described above. Thus, if the write environment changes while the control program is written, it is possible to stop or suspend the write processing.

Subsequently, a process of writing to the engine control unit 20 begins as illustrated in FIG. 5. First, it is determined in decision block 300 whether a writing instruction signal is received from another control unit 9. If decision block 300 is answered negatively, the process terminates. However, if decision block 300 is answered affirmatively, the procedure proceeds to step 310 to begin a writing process of a control program, such as a write control program.

Then, in decision block 320, it is determined whether a writing suspension signal has been received from any control unit 9 other than the engine control unit 20. If decision block 320 is answered affirmatively, the process terminates to stop the writing process of the control program. However, if decision block 320 is answered negatively, the procedure proceeds to decision block 330 to determine whether all control programs intended to be written have been written to the flash ROM 20c.

If decision block 330 is answered negatively, the procedure returns to step 310 to again perform the writing process. However, if decision block 330 is answered affirmatively, step 340 follows, and a writing process termination signal is transmitted to the control unit 9 that includes the write environment determination program.

Also, in one embodiment, the engine control unit 20 and the control unit 9 that includes the write environment determination program both transmit one or more signals indicative of the status of writing process to the meter control unit 40. Thus, the meter control unit 40 can display the status of the writing process to the user. In an embodiment in which the meter control unit 40 includes the writing environment determination program, the status signals are not transmitted because the meter control unit 40 itself determines the status of the writing process.

Although preferred embodiments of the invention have been described, the invention is not limited to the embodiments described above. Variations on the embodiments described above can be made without departing from the scope of the invention.

For instance, although the control program is written on the flash ROM 20c of the engine control unit 20 in the embodiments described above, the control program may be written on a control unit 9 other than the engine control unit 20. Also, control programs may be written to a plurality of control units 9.

Furthermore, once the control program is written to the respective control unit 9, the memory write device 10 may collect version information of control programs as stored from the respective control units 9 to thereby determine compatibility of the respective control programs on the basis of the collected version information.

In some cases, the control programs of the control units 9 are version-updated in remodeling or the like, and data is varied in kind, size, etc. If the control programs of the control units 9 are incompatible in version, communication of mutually necessary data may not occur. To avoid such a problem, the memory write device 10 collects version information of the control programs of the respective control units 9 to determine compatibility thereof. Accordingly, it is possible to more assuredly detect a state of incompatibility. In another embodiment, one or more of the control units 9 collects version information instead of the memory write device 10.

What is claimed is:

1. A vehicle control system for a vehicle comprising:
a communication network; and
a plurality of control units in communication with each other via the communication network;
wherein at least one of the plurality of control units includes a nonvolatile memory device with a write environment determination program written thereon;
wherein the at least one of the plurality of control units receives vehicle data from at least one other control unit;
wherein the write environment determination program is run to determine whether a writing environment is appropriate based on the vehicle data, and a writing process of the control program commences when it is determined that the writing environment is appropriate.

2. The vehicle control system according to claim 1, wherein the at least one control unit receives redundant vehicle data.

3. The vehicle control system according to claim 1, wherein the at least one control unit again runs the write environment determination program after the writing process has commenced.

4. The vehicle control system according to claim 1, further comprising a display for displaying the status of the writing process.

5. The vehicle control system according to claims 1, wherein the at least one control unit includes a control program and transmits version information of the control program through the communication network, and wherein at least one other of the plurality of control units collects the version information to determine compatibility of the control program.

6. A vehicle control system for a vehicle comprising:
a communication network; and
a plurality of control units in communication with each other via the communication network;
wherein a first control unit of the plurality of control units includes a nonvolatile memory device with a control program written thereon and a write program written thereon, wherein the write program is used for a writing process of the control program;
wherein a second control unit of the plurality of control units includes a write determination program written thereon, the write determination program is run to determine whether a writing environment is appropriate; and
wherein the first control unit commences the writing process of the control program when the second control unit determines that the writing environment is appropriate.

7. The vehicle control system according to claim 6, wherein the second control unit again runs the write environment determination program after the writing process has commenced.

8. The vehicle control system according to claim 6, further comprising a display for displaying the status of the writing process.

9. The vehicle control system according to claims 6, wherein the first control unit transmits version information of the control program through the communication network and at least one other of the plurality of control units collects the version information to determine compatibility of the control program.

10. A method for writing a control program of a vehicle control system, wherein the vehicle control system comprises a plurality of control units, the method comprising:
acquiring vehicle data by a control unit;
transmitting the vehicle data to another control unit;
determining whether a write environment is appropriate based on the vehicle data;
commencing a writing process of the control program when it is determined that the write environment is appropriate.

11. The method of claim 10 wherein transmitting comprises transmitting redundant vehicle data to the other control unit.

12. The method of claim 10 wherein, after commencing the writing process, the method further comprises determining whether the write environment is appropriate.

13. The method of claim 10 further comprising displaying the status of the writing process.

14. The method of claim 10 further comprising transmitting version information of the control program, and determining compatibility of the control program based on the version information.
